(19) United States
(12) Patent Application Publication
(10) Pub. No.: US 2007/0278349 A1
(43) Pub. Date: Dec. 6, 2007

(54) Helicopter-borne power line deicer

(75) Inventors: Anthony Adam Bembridge, Yellowknife (CA); Ian David Hayne, Yellowknife (CA)

Correspondence Address: OYEN, WIGGS, GREEN & MUTALA LLP;480 - THE STATION, 601 WEST CORDOVA STREET, VANCOUVER, BC, V6B 1G1, US

(73) Assignee: Great Slave Helicopters Ltd., Yellowknife (CA)

(21) Appl. No.: 11/445,383

(22) Filed: Jun. 2, 2006

(51) Int. Cl. B64D 15/16

(52) U.S. Cl. 244/134 R

(57) ABSTRACT

A deicer for removing ice or snow from a high voltage electric power transmission line suspended between opposed supports. The deicer incorporates a frame, a tether, an electric power source and a vibrator. One end of the tether is attachable to the frame; the tether's opposed end is attachable to a helicopter. The electric power source is mounted on the frame. The vibrator is mounted on the frame, and is electrically connected to the power source, which is remotely operable from within the helicopter. Vibratory forces produced by the vibrator are applied to the power line, dislodging accumulated snow and ice from the power line.

### TECHNICAL FIELD

A helicopter-transportable and controllable high voltage electric power transmission line deicer having a vibrator to dislodge snow and ice from the power line while the deicer is rollably positioned on the power line.

### BACKGROUND

High voltage electric power transmission lines located in regions prone to blizzards, freezing rain, etc. can accumulate significant snow or ice loads. If the weight of the accumulated snow or ice becomes excessive the power line may be damaged. For example, the weighted power line may sag and contact a tree or other object, resulting in a short circuit and disrupting the power line's electric power transmission capability. The weighted power line may also break away from its support structure, or the line itself may break if it is incapable of supporting the weight of the accumulated snow or ice-again disrupting the power line's electric power transmission capability. In an extreme case, the weight of an ice or snow-bearing power line may damage the power line's support structure. Electric power transmission lines located in such regions are accordingly inspected regularly to detect snow or ice accumulation. Efforts are made to dislodge snow and ice from such lines before the accumulating snow and ice can disrupt the power line's electric power transmission capability. The power line deicer described below assists such efforts.

### BRIEF DESCRIPTION OF DRAWINGS

Exemplary embodiments are illustrated in referenced figures of the drawings. The embodiments and figures disclosed herein are to be considered illustrative rather than restrictive.

FIG. 1 is a front elevation view of the power line deicer.

FIG. 2 is a rear elevation view thereof.

FIG. 3 is a left side elevation view thereof and schematically shows three different power line positions to illustrate maneuvering of the deicer into rollable position on the power line.

FIG. 4 is a partially sectioned left side elevation view showing an alternative vibrator arrangement.

FIG. 5 schematically and pictorially shows a helicopter towing the deicer along a power line after maneuvering the deicer into position on the power line. The helicopter and deicer are depicted on an enlarged scale, relative to the power line and its support structure.

FIG. 6 is a partially fragmented, partially sectioned front elevation view, on an enlarged scale, of the vibrator head portion of the power line deicer.

FIG. 7 is a partially sectioned left side elevation view of the vibrator head portion of the power line deicer.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

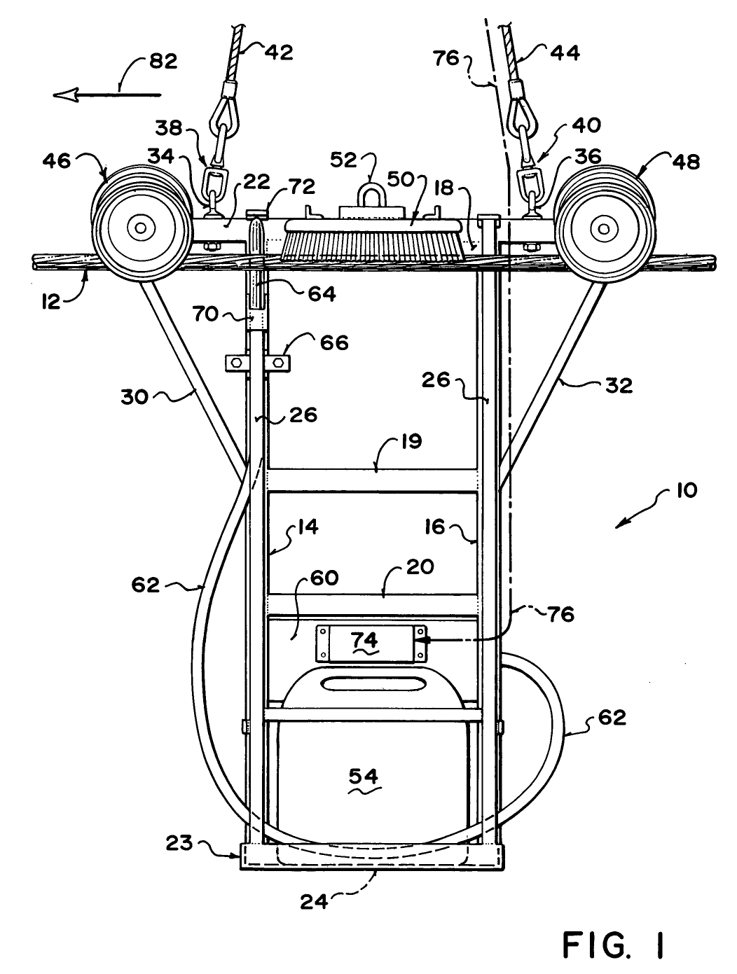

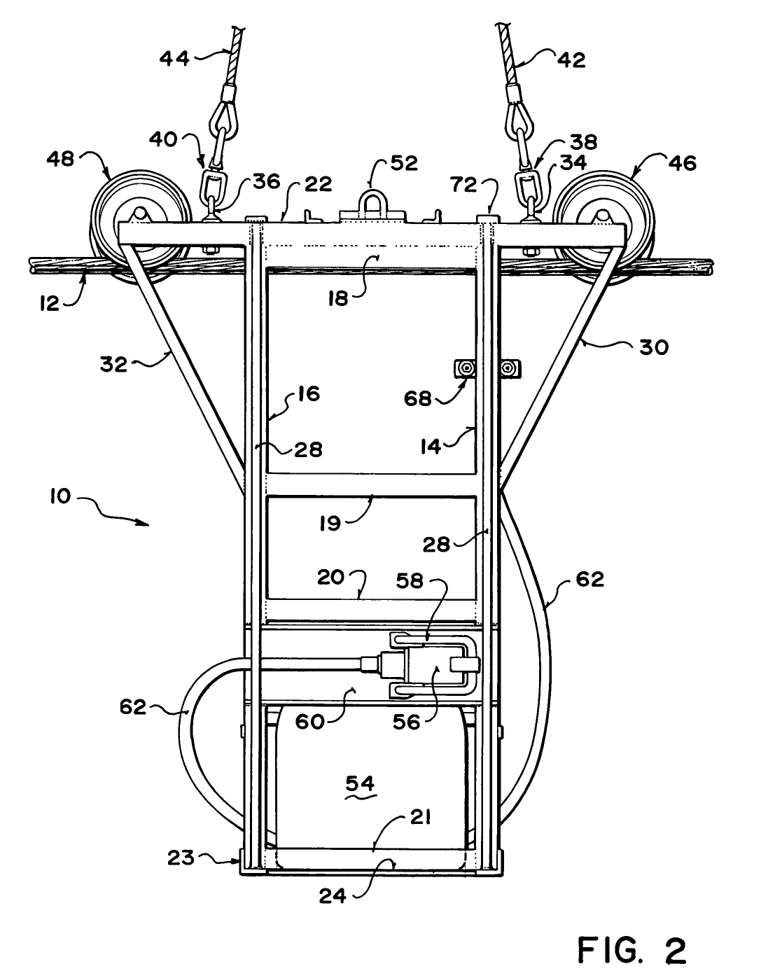

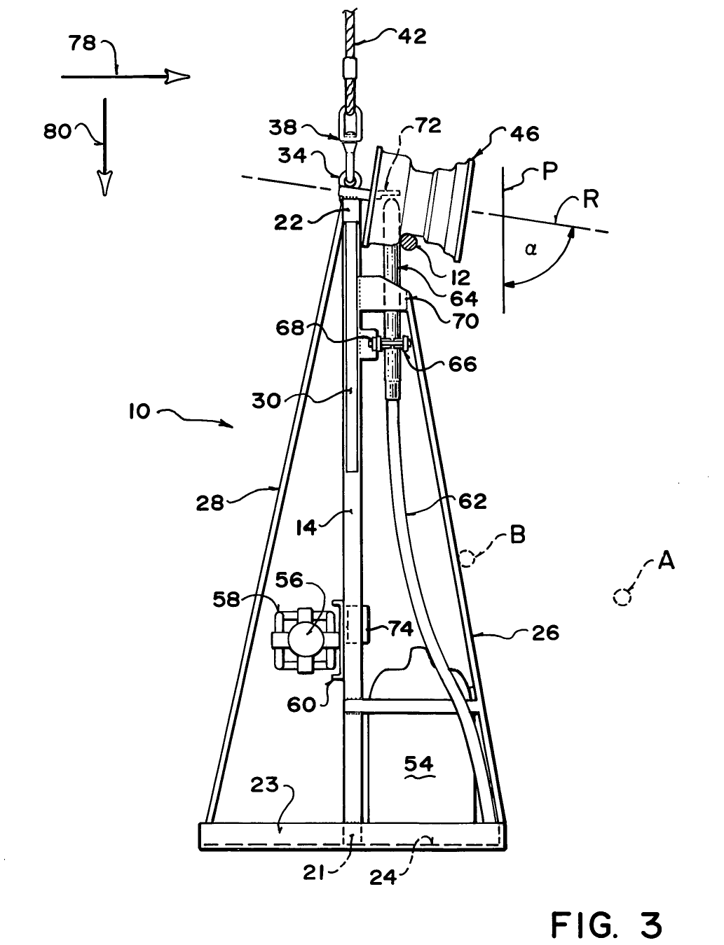

FIGS. 1, 2 and 3 depict a power line deicer 10 rollably positioned atop a high voltage electric power transmission line or cable 12. Deicer 10 incorporates a frame having a pair of spaced vertical steel members 14, 16 fixed (e.g. welded) between horizontal steel braces 18, 19, 20, 21. Steel support beam 22 is fixed (e.g. welded) atop and extends outwardly beyond the opposed ends of vertical members 14, 16. Steel platform support frame 23 is fixed (e.g. welded) to the lower ends of vertical members 14, 16 and extends forwardly and rearwardly thereof, as best seen in FIG. 3. Steel horizontal platform 24 is fixed (e.g. welded) within and supported by frame 23. Opposed pairs of steel forward and rearward bracing struts 26, 28 are fixed (e.g. welded) between the upper ends of vertical members 14, 16 and the opposed forward and rearward corners of platform support frame 23. Steel lateral bracing struts 30, 32 are fixed (e.g. welded) between the opposed outward ends of support beam 22 and the outward, central, side portions of vertical members 14, 16 respectively.

Eye bolts 34, 36 are fastened through and protrude atop support beam 22, outside vertical members 14, 16 respectively. Shackles 38, 40 are coupled to eye bolts 34, 36 respectively. Harness cables 42, 44 are in turn coupled to shackles 38, 40.

Wheel hubs 46, 48 are rotatably mounted on the opposed outward ends of the forward side of support beam 22. As best seen in. FIG. 3, hubs 46, 48 are mounted so that their rotational axes R extend forwardly and downwardly at an acute angle a relative to a notional plane P substantially parallel to a plane containing vertical members 14, 16 and support beam 22. This assists in maintaining deicer 10 atop power line 12, and also assists in maintaining vibrational contact with power line 12, after deicer 10 is positioned atop power line 12 and operated as explained below.

Stiff-bristled brush 50 (FIG. 1) is mounted on the same (i.e. forward) side of support beam 22 as wheel hubs 46, 48 and between vertical members 14, 16 such that brush 50's bristles will contact power line 12, after deicer 10 is positioned atop power line 12 as explained below.

Optional hoisting bracket 52 can be fixed (e.g. welded) centrally atop support beam 22 for use in ground-based manipulation and maintenance of deicer 10.

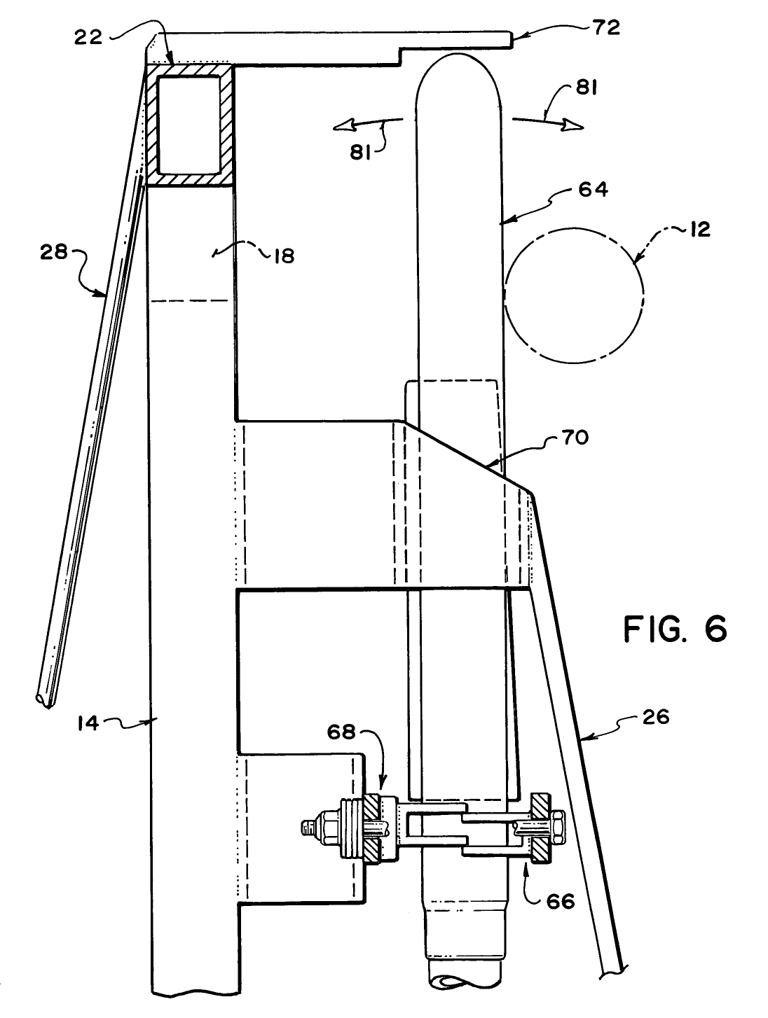

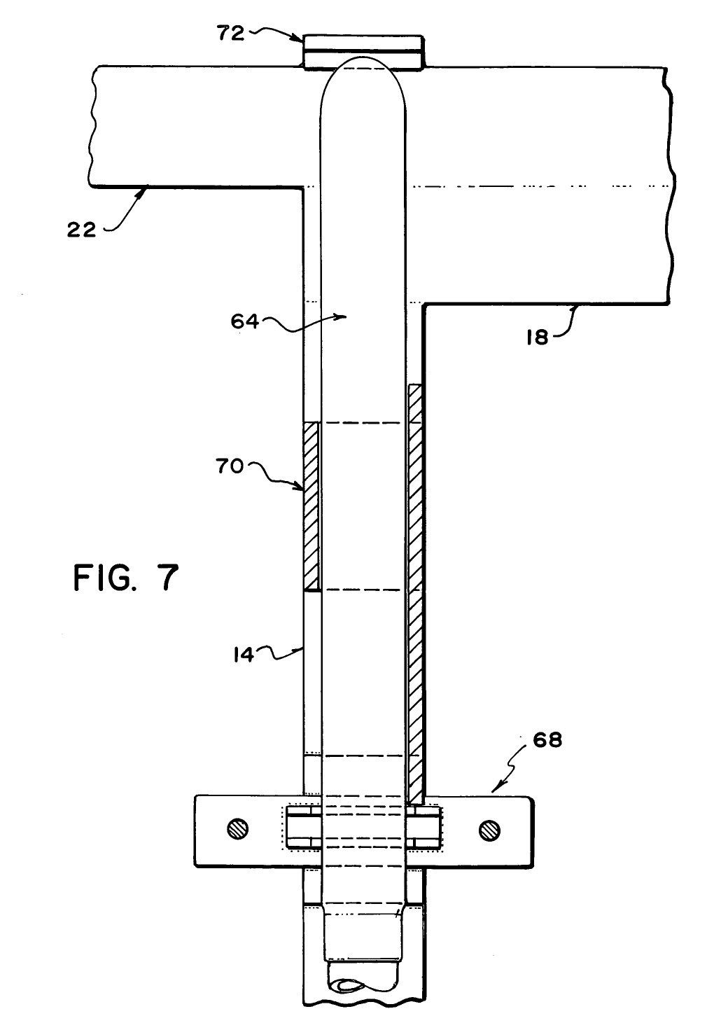

A conventional concrete vibrator, such as a one incorporating an electric motor model no. 1.2 OZ, a shaft part no. FS 07 OZ and a head part no. H 125 OZ-all available from Oztec Industries, Inc. of Port Washington, N.Y. is mounted on deicer 10. Specifically, gasoline engine powered electric power generator 54 is fastened (e.g. strapped or bolted) atop platform 24 and electrically connected to air motor 56, which is mounted in support bracket 58. Support bracket 58 is fastened (e.g. bolted) to steel mounting plate 60, which is fixed (e.g. welded) in a lower central region between vertical members 14, 16. Air hose 62 is coupled between air motor 56 and vibrator head 64. As best seen in FIGS. 6 and 7, vibrator head 64 is mounted on the forward side of support beam 22, in longitudinal alignment with and spaced forwardly from the upper forward end of vertical member 14. Clamp 66 is tightened over the lower end of vibrator head 64 against steel bracket 68, which is fixed (e.g. welded) to the forward side of vertical member 14 and extends transversely to either side thereof. Steel sleeve 70 is formed at the juncture of vertical member 14 and the leftward (as viewed in FIG. 1) one of bracing struts 26 to assist in retaining vibrator head 64 in position on deicer 10. Steel stop flange 72 is fixed (e.g. welded) atop and projects forwardly of support beam 22, in alignment with vertical member 14, to limit upward and forward-rearward movement of vibrator head 64. Vibrator head 64 can be biased forwardly to improve contact with power line 12, for example by welding a suitable shim to vertical member 14.

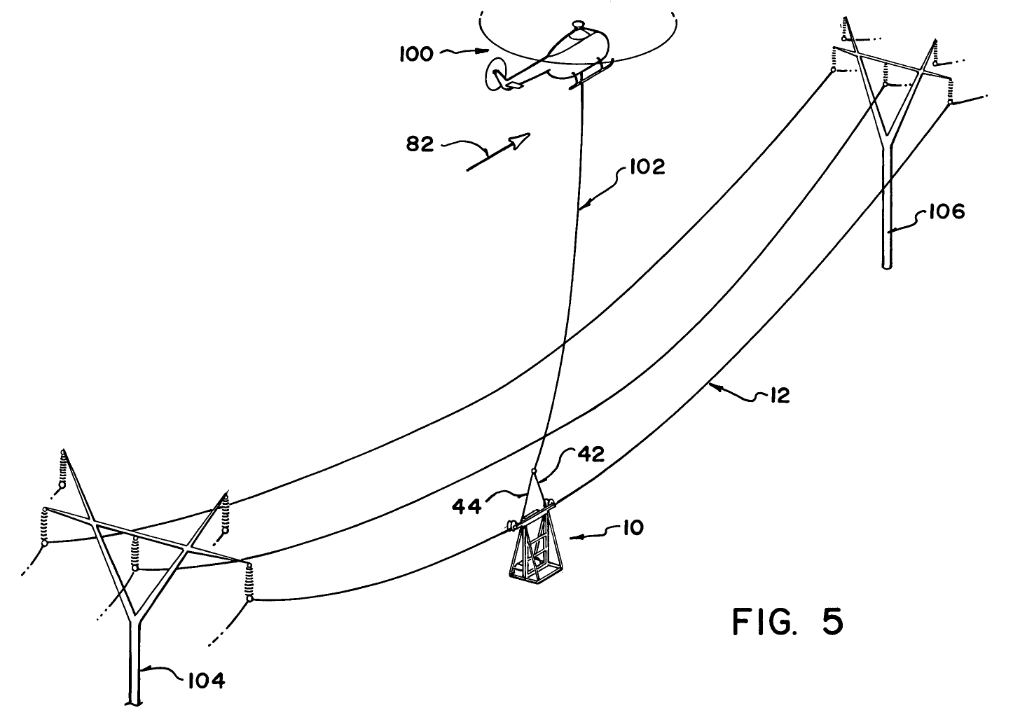

The concrete vibrator's electronic control unit 74 is fastened (e.g. bolted) to mounting plate 60, opposite air motor 56. Control unit 74 is electrically coupled to air motor 56 and to generator 54. As illustrated by dashed line 76 (FIG. 1) control unit 74 is also electrically connected to a remote controller (not shown) located within helicopter 100 (FIG. 5).

In operation, deicer 10 is suspended beneath helicopter 100 on tether 102, and the tether's lower end is coupled to harness cables 42, 44 as shown in FIG. 5. High voltage electric power transmission line or cable 12 is commonly supported between a pair of towers 104, 106 and is typically one of several (e.g. three) substantially parallel power lines supported at spaced intervals by towers 104, 106. After detection of snow or ice accumulation on power line 12, a pilot manoeuvres helicopter 100 to position deicer 10 with support beam 22 extending substantially parallel to power line 12 such that power line 12 is approximately in dashed line position “A” (FIG. 3) relative to deicer 10. Then, as indicated by arrows 78 and 80 in FIG. 3, the pilot manoeuvres helicopter 100 to move deicer 10 transversely and downwardly toward power line 12, until forward struts 26 contact power line 12, as indicated in FIG. 3 by dashed line position “B”. The pilot then continues to manoeuver helicopter 100 to move deicer 10 further transversely and downwardly, such that forward struts 26 slide transversely and downwardly against power line 12 until wheel hubs 46, 48 contact and are rollably positioned atop power line 12 as seen in FIGS. 1, 2 and 3.

After deicer 10 is rollably positioned atop power line 12, the pilot (or another person in helicopter 100) actuates control unit 74 via the remote controller electrically coupled thereto to start generator 54, thus supplying electric power to air motor 56 which delivers pressurized air through hose 62 to vibrator head 64, causing vibrator head 64 to rapidly vibrate forwardly and rearwardly as indicated by arrows 81 in FIG. 6. As best seen in FIGS. 3 and 6, vibrator head 64 contacts power line 12 when deicer 10 is rollably positioned atop power line 12, due to the above-described forward and downward extent of the rotational axes R of wheel hubs 46, 48. Vibratory force produced by vibrator head 64 is accordingly continually applied directly to power line 12, dislodging accumulated snow and ice from power line 12.

If the vibratory force is insufficient to dislodge substantially all snow and ice accumulated along power line 12 between towers 104, 106 the pilot can manouevre helicopter 100 as indicated by arrow 82 in FIGS. 1 and 5 to slowly tow deicer 10 along an upwardly inclined section of power line 12, or to allow deicer 10 to slowly roll along a downwardly inclined section of power line 12. Such towing or rolling is facilitated by wheel hubs 46, 48 which roll along power line 12 as deicer 10 moves therealong. As deicer 10 moves along power line 12, snow and ice contacted by brush 50's bristles is swept off power line 12, complementing the snow and ice dislodgment capability of vibrator head 64. The portions of wheel hubs 46, 48 which contact power line 12 may be optionally coated with rubber or a similar material to reduce skidding or slippage of wheel hubs 46, 48 as deicer 10 is towed along power line 12.

After deicer 10 has been operated to sufficiently dislodge accumulated snow and ice from power line 12 between towers 104, 106 the pilot (or another person in helicopter 100) actuates control unit 74, via the remote controller electrically coupled thereto, to deactivate generator 54, thus stopping the supply of electric power to air motor 56 and placing vibrator heard 64 in an inactive (i.e. non-vibrating) state. The pilot then manoeuvres helicopter 100 to move deicer 10 transversely and upwardly away from power line 12. The pilot can then manouevre helicopter 100 to move deicer 10 to another power line from which accumulated snow and ice is to be dislodged.

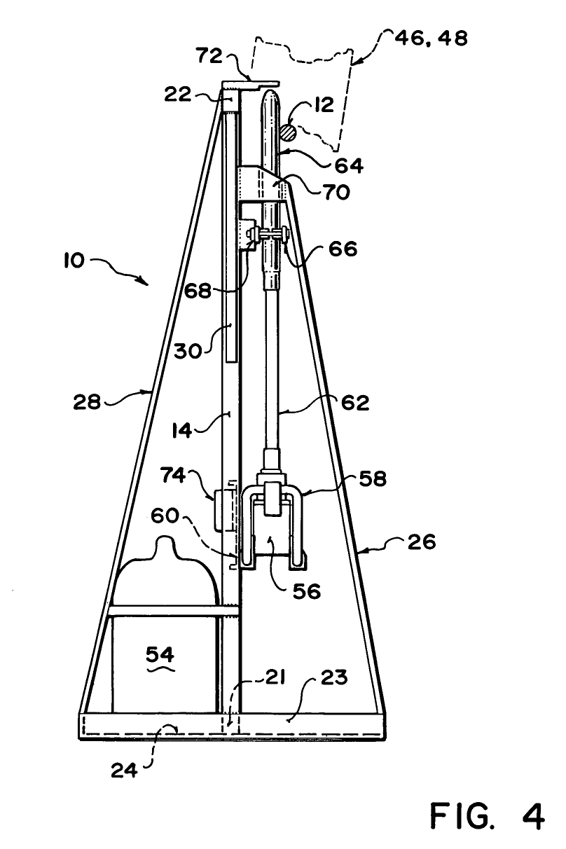

FIG. 4 is similar to FIG. 3, except that air hose 62 is shortened to facilitate vertical positioning of air motor 56 directly beneath vibrator head 64. This arrangement is somewhat more compact than the arrangement depicted in FIGS. 1, 2 and 3 but may require modification of air hose 62 if a sufficiently short hose is unavailable as a stock purchase item for use with air motor 56 and vibrator head 64.

While a number of exemplary aspects and embodiments have been discussed above, those of skill in the art will recognize certain modifications, permutations, additions and sub-combinations thereof. For example, instead of providing a pair of wheel hubs 46, 48 one may provide a single wheel hub positioned centrally atop support beam 22.

As another example, one may substitute a pair of flanged rollers for wheel hubs 46, 48 (or a single flanged roller positioned centrally atop support beam 22). Alternatively, a cushioned, inverted-V shaped pad could be substituted for wheel hubs 46, 48 or for a roller or rollers, although such a pad may prevent towing of deicer 10 along power line 12.

As a further example, the relatively heavy gasoline engine powered electric power generator 54 is advantageously mounted on a lower part of deicer 10's frame (e.g. on platform 24) in order to lower deicer 10's center of gravity, but such mounting is not essential. Persons skilled in the art will also understand that an alternative electric power source such as a battery, fuel cell or inverter could be substituted for generator 54. Moreover, instead of using an electric power source such as generator 54, one could use a non-electric power source and a vibrator which does not require electric power. For example, a mechanically actuated vibrator could be mechanically coupled to a gasoline powered engine.

As yet another example, generator 54 could be mounted anywhere on deicer 10's frame although it is preferably mounted low on the frame to improve in-flight stability and so that generator 54 does not impede the helicopter's pilot's visibility of wheel hubs 46, 48 during placement of deicer 10 on power line 12 or while deicer 10 is towed along power line 12.

As a still further example, it is not essential that vibrator head 64 contact power line 12 as previously described, although such contact is preferred. Adequate dislodgment of snow and ice from power line 12 can be attained even if vibrator head 64 does not contact power line 12, since vibratory forces produced by vibrator head 64 cause deicer 10 to vibrate in its entirety, thus imparting adequate vibrational forces to power line 12.

It is therefore intended that the appended claims and claims hereafter introduced be interpreted to include all such modifications, permutations, additions and sub-combinations as are within their true spirit and scope.

What is claimed is:

1. Apparatus for removing ice or snow from a cable suspended between opposed supports, the apparatus comprising:
(a) a frame;
(b) a tether having one end attachable to the frame and an opposed end attachable to a helicopter;
(c) a power source mounted on the frame; and
(d) a vibrator mounted on the frame and operatively connected to the power source.

2. Apparatus as defined in claim 1, further comprising at least one flanged roller rotatably mounted on and protruding to one side of the frame for rollable positioning of the roller on the cable.

3. Apparatus as defined in claim 2, wherein the roller is rotatably mounted on an upper part of the frame.

4. Apparatus as defined in claim 1, further comprising spaced apart first and second flanged rollers rotatably mounted on and protruding to one side of the frame, for rollable positioning of the rollers on the cable.

5. Apparatus as defined in claim 4, wherein the rollers are rotatably mounted on an upper part of the frame.

6. Apparatus as defined in claim 3, wherein the power source is mounted on a lower part of the frame.

7. Apparatus as defined in claim 5, wherein the power source is mounted on a lower part of the frame.

8. Apparatus as defined in claim 1, wherein the vibrator is mounted on the frame for contact with the cable.

9. Apparatus as defined in claim 1, wherein the power source is an electric power source and wherein the vibrator is electrically connected to the power source, the apparatus further comprising a controller operatively connectible to the power source and to the vibrator, the controller operable to select one of:
(i) an operative state in which the vibrator is electrically actuated by the power source to vibrate the vibrator and to impart vibration to the cable; and
(ii) an inoperative state in which the vibrator does not vibrate.

10. Apparatus as defined in claim 9, wherein the controller is mountable within the helicopter.

11. Apparatus as defined in claim 10, further comprising an electrical conductor electrically connected between the controller, the power source and the vibrator.

12. Apparatus as defined in claim 11, wherein the electrical conductor extends along the tether from the frame to the helicopter.

13. Apparatus as defined in claim 2, further comprising a brush mounted on the frame to sweep the cable when the roller is on the cable.

14. Apparatus as defined in claim 4, further comprising a brush mounted on the frame between the rollers.

15. Apparatus as defined in claim 4, further comprising a brush mounted on the frame to sweep the cable when the rollers are on the cable.

16. Apparatus as defined in claim 3, wherein the roller is mounted on the frame for rotation about a rotational axis which extends forwardly and downwardly at an acute angle relative to a notional plane substantially parallel to the frame.

17. Apparatus as defined in claim 5, wherein each roller is mounted on the frame for rotation about a rotation axis which extends forwardly and downwardly and forwardly at an acute angle relative to a notional plane substantially parallel to the frame.

18. A method of removing ice or snow from a cable suspended between opposed supports, the method comprising:
(a) tethering a frame to a helicopter;
(b) mounting a vibrator on the frame;
(c) manoeuvring the helicopter to suspend the frame on the cable; and
(d) operating the vibrator to vibrate the frame and the cable.

19. A method as defined in claim 18, further comprising mounting the vibrator on the frame for contact of the cable by the vibrator.

20. A method as defined in claim 18, further comprising:
(a) providing at least one rotatable roller on the frame; and
(b) manoeuvring the helicopter to position the roller on the cable.

21. A method as defined in claim 20, further comprising manoeuvring the helicopter to tow the frame along the cable.

22. A method as defined in claim 20, further comprising remotely operating the vibrator from within the helicopter.
